(19) United States
(12) Patent Application Publication
(10) Pub. No.: US 2024/0255696 A1
(43) Pub. Date: Aug. 1, 2024

(54) SYSTEMS AND METHODS FOR INTEGRATION OF THIN FILM OPTICAL MATERIALS IN SILICON PHOTONICS

(71) Applicant: Raytheon Company, Tewksbury, MA (US)

(72) Inventor: Ping Piu KUO, San Diego, CA (US)

(21) Appl. No.: 18/633,331

(22) Filed: Apr. 11, 2024

Related U.S. Application Data
(63) Continuation of application No. PCT/US2022/050622, filed on Nov. 21, 2022.
(60) Provisional application No. 63/284,562, filed on Nov. 30, 2021.

(51) Int. Cl. G02B 6/12; G02B 6/132

(52) U.S. Cl. CPC G02B 6/12004; G02B 6/132; G02B 2006/1204

(57) ABSTRACT

A method of fabricating a photonics stack includes providing a silicon photonics structure having a silicon substrate, an oxide layer, and an epitaxial silicon layer with one or more active devices. The method also includes providing an interposer structure and attaching the silicon photonics structure and the interposer structure. The method further includes removing the silicon substrate from the silicon photonics structure and removing at least a portion of the oxide layer from the silicon photonics structure. In addition, the method includes disposing a thin film lithium niobate coupon on or within the silicon photonics structure and encapsulating the thin film lithium niobate coupon with an optical material.

### CROSS-REFERENCE TO RELATED APPLICATION AND PRIORITY CLAIM

This application is a bypass continuation of International Patent Application No. PCT/US2022/050622 filed on Nov. 21, 2022, which claims the benefit of U.S. Provisional Patent Application No. 63/284,562 filed on Nov. 30, 2021. Both of these applications are hereby incorporated by reference in their entirety.

### TECHNICAL FIELD

This disclosure is generally directed to optical systems. More specifically, this disclosure is directed to systems and methods for integration of thin film optical materials in silicon photonics.

### BACKGROUND

Advances in silicon photonics have led to the first realizations of millimeter-scale optical chips containing numerous devices. These chips can support diverse optical functions, such as polarization management, management of programmable optical filter banks, and high-speed modulators and photodetectors operating at performance levels near or exceeding the performance levels of discrete optical devices. In some cases, multiple-waveguide systems may be supported by complementary metal oxide semiconductor (CMOS) fabrication process flows that can enable low-loss optical interfacing with external devices, such as III-V-based lasers and optical fibers.

### SUMMARY

This disclosure relates to systems and methods for integration of thin film optical materials in silicon photonics.

In a first embodiment, a photonics device includes a silicon waveguide structure disposed in a first plane. The photonics device also includes a plurality of modulator electrodes, where at least a portion of each of the modulator electrodes is disposed in the first plane. The photonics device further includes an optical material disposed in a second plane adjacent the first plane.

In a second embodiment, a photonics stack includes a silicon layer that has an active device and that is positioned in a first plane, where the active device is disposed at a lateral position of the silicon layer. The photonics stack also includes a lithium niobate structure positioned in a second plane adjacent the first plane, where the lithium niobate structure is disposed at the lateral position.

In a third embodiment, a method of fabricating a photonics stack includes providing a silicon photonics structure having a silicon substrate, an oxide layer, and an epitaxial silicon layer with one or more active devices. The method also includes providing an interposer structure and attaching the silicon photonics structure and the interposer structure. The method further includes removing the silicon substrate from the silicon photonics structure and removing at least a portion of the oxide layer from the silicon photonics structure. In addition, the method includes disposing a thin film lithium niobate coupon on or within the silicon photonics structure and encapsulating the thin film lithium niobate coupon with an optical material.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIGS. 1A and 1B illustrate example cross-sectional views of photonics devices having thin film photonics structures according to this disclosure;

FIG. 2 illustrates an example cross-sectional view of a photonics device having an optically-active photonics structure according to this disclosure;

FIGS. 3A through 3M illustrate example techniques for fabricating photonics stacks according to this disclosure;

FIGS. 4A and 4B illustrate example views of a waveguide and modulator electrodes in a silicon photonics structure of a photonics device and related details according to this disclosure;

FIGS. 5A through 5C illustrate example operational characteristics of a silicon photonics modulator according to this disclosure;

FIGS. 6A through 6E illustrate an example optical waveguide and associated operational features according to this disclosure; and

FIGS. 7A and 7B illustrate example characteristics of a silicon photonics modulator according to this disclosure.

### DETAILED DESCRIPTION

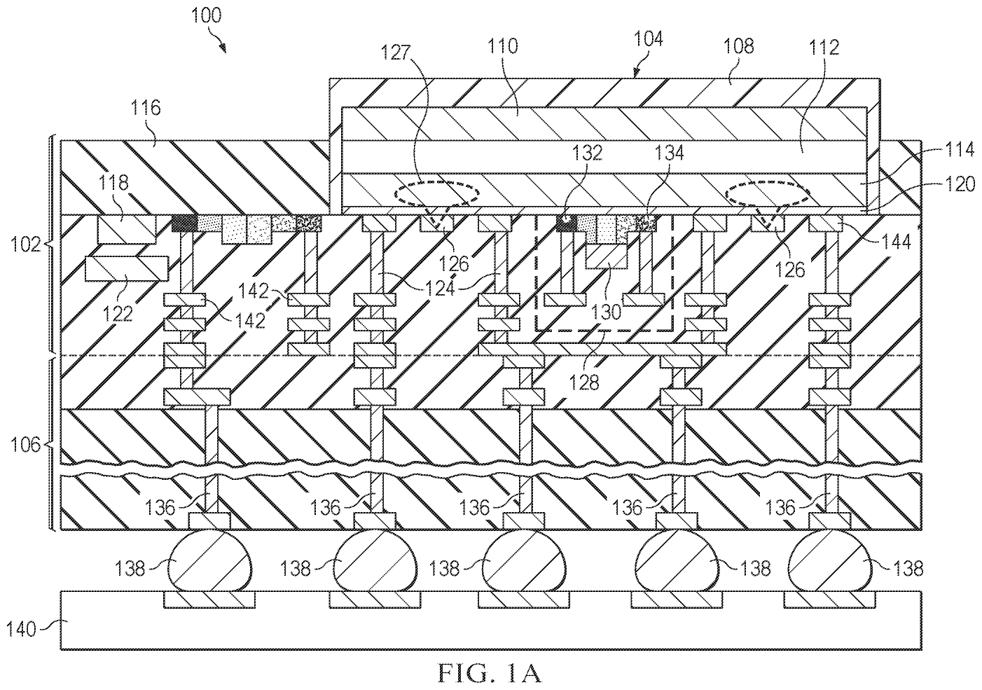

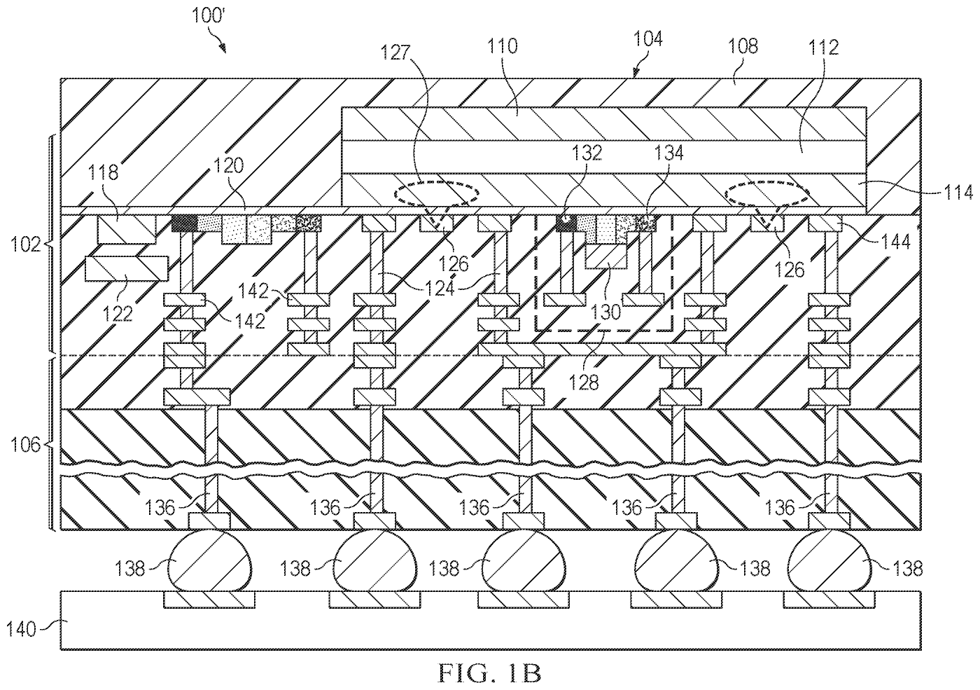

FIGS. 1A through 7B, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

As described above, advances in silicon photonics have led to the first realizations of millimeter-scale optical chips containing numerous devices. These chips can support diverse optical functions, such as polarization management, management of programmable optical filter banks, and high-speed modulators and photodetectors operating at performance levels near or exceeding the performance levels of discrete optical devices. In some cases, multiple-waveguide systems may be supported by complementary metal oxide semiconductor (CMOS) fabrication process flows that can enable low-loss optical interfacing with external devices, such as III-V-based lasers and optical fibers.

While silicon photonics have experienced widespread adoption in lightwave communications (where discrete digital transceiver optics have been readily replaced by chip-scale counterparts), the use of silicon photonics in microwave and/or analog applications is sparse. Among other reasons, this deficiency is driven by the poor noise figure (NF) of silicon photonic transceivers, which remains at least an order of magnitude higher than that of state-of-the-art discrete photonic microwave transceivers. This deficiency originates from (i) two-photon absorption (TPA) that imposes strict power limitations and (ii) excess loss due to free-carrier absorption (FCA) in silicon modulators. Moreover, the intrinsic nonlinearity of a silicon modulator is defined by its square root tuning characteristics (its phase shift φ is proportional to V^{1/2}) and typically demands a significant reduction in modulation to suppress distortions, which fundamentally degrades the noise figure of silicon-based photonic microwave links.

Lithium niobate (LN) integration into a silicon photonics platform can allow a combination of the benefits of high-density integration with linear and power-scalable modulation enabled by a ceramic material system. Current lithium niobate integration process flows may include bonding a thin-film lithium niobate (TFLN) chiplet onto a front-side of a patterned silicon- or silicon nitride-on-insulator (SOI or SNOI) substrate via plasma-activated direct bonding or polymer-assisted bonding, which may be followed by removal of the TFLN substrate. Optical waveguides on or in the lithium niobate film can be formed by partial etching using argon ion beam milling or by evanescently coupling to the silicon/silicon nitride strip to form hybrid guided modes. Finally, metal may be deposited and patterned on top of the TFLN to form radio frequency (RF) electrodes and optionally direct current (DC) bias electrodes of a modulator.

Unfortunately, these approaches suffer from several major drawbacks. First, these approaches may require that the area bonded with the TFLN be devoid of other optical or electrical devices. Since the TFLN layer typically needs to be in close proximity to the underlying waveguides (such as within about 200 nanometers) for low-loss mode transition, this precludes the colocation of TFLN with active photonic and electrical devices that may include in-situ contacts and metallization. This restriction can severely impact integration density since the size of lithium niobate modulators can be on the order of several centimeters. Also, low local metal density can cause non-uniform metal sheet resistance due to dishing and non-uniform etch rates. Low local metal density further impacts manufacturability, and large variations in metal density across a chip can induce significant stresses to back-end-of-the-line dielectrics, such as due to effective thermal expansion coefficient (C_{TE}) mismatches. In addition, significant dielectric film and metal trace thickness deviations can occur in regions near the TFLN bonding window due to dishing, which can impact manufacturing yields and reduce performance. Second, as electrodes and waveguides formed on or in the lithium niobate are patterned separately, the respective photolithography steps need to be performed with high precision (such as with a sub-100 nanometer alignment tolerance). A lack of precise alignment can cause significant losses or significant modulation efficiency imbalances between modulator arms.

This disclosure provides various systems and methods for integration of thin film optical materials in silicon photonics. For example, embodiments of this disclosure enable the integration of nonlinear, active, and/or light-emitting optical materials (such as lithium niobate) in silicon photonics that can gain functionality, lower the noise figure, provide improved linearity, and/or provide improved bandwidth performance in comparison to silicon photonics transceivers and processors. In various embodiments of this disclosure, the systems and methods disclosed here can reduce the size, weight, and/or power (SWaP) metric of state-of-the-art silicon photonics devices by at least an order of magnitude. In some cases, the disclosed systems and methods can enable silicon photonics modulators to handle powers in excess of 300 milliwatts, rivaling the power handling capabilities provided by discrete optical modulators. Furthermore, embodiments of this disclosure can enable high density integration, thereby achieving equivalent integration densities as state-of-the-art silicon photonics circuits.

FIGS. 1A and 1B illustrate example cross-sectional views of photonics devices 100 and 100′ having thin film photonics structures according to this disclosure. More specifically, FIGS. 1A and 1B illustrate example cross-sectional views of silicon photonics devices having thin film lithium niobate (TFLN) photonics structures. As shown in FIG. 1A, the photonics device 100 can include a silicon photonics structure 102 and a TFLN photonics structure 104. However, in other embodiments, the TFLN photonics structure 104 may be replaced by other optical materials or structures such that the optical materials or structures are optically coupled to the silicon photonics structure 102. For example, other implementations of the photonics structure 104 may use different non-linear optical materials.

In this example, the silicon photonics structure 102 can include modulator electrodes 124, waveguides 126, and one or more active devices 128. The modulator electrodes 124 represent electrical connections of a silicon photonics modulator and may be formed using any suitable electrically-conductive material(s), such as one or more metals. The waveguides 126 represent pathways for optical signals and may be formed using any suitable optical transporting material(s), such as crystalline silicon, polysilicon, silicon nitride, or silicon oxynitride. The active devices 128 represent one or more semiconductor devices formed in the silicon photonics structure 102, such as one or more germanium-based photodiodes or other suitable semiconductor devices. Each active device 128 is disposed at a specified lateral position in a silicon layer of the silicon photonics structure 102.

The TFLN photonics structure 104 can be bonded or otherwise attached to a backside of the silicon photonics structure 102, enabling colocation of the modulator electrodes 124, waveguides 126, and active devices 128 adjacent to the TFLN photonics structure 104. In this way, a relatively high level of integration density can be achieved, compared to current approaches of integrating thin film lithium niobate devices with silicon photonics devices.

The waveguides 126 present in the silicon photonics structure 102 can be optically coupled to a TFLN layer 114 in the TFLN photonics structure 104, such as through a polymer dielectric 120 (which includes an electrically-insulative polymer as the name implies). The TFLN layer 114 represents a thin film formed using lithium niobate, although other materials may be used as noted above. The TFLN layer 114 here is disposed at the same lateral position(s) as the active device(s) 128.

By including the modulator electrodes 124 and waveguides 126 in the silicon photonics structure 102, an optical mode 127 and modulating electric fields can be self-aligned. This self-alignment can be achieved because the modulator electrodes 124 that produce the modulating electric fields in the TFLN layer 114 are in close proximity to the waveguide 126. Even if the TFLN layer 114 shifts due to misalignment, the optical mode 127 and the modulating electric fields can still remain aligned. The inherent self-alignment of the electro-optical structure in the disclosed systems and methods can reduce or eliminate impairments due to in-plane misalignment that exists in current approaches. This can allow silicon photonics modulator performance, such as insertion loss and modulation efficiency, to be insensitive to placement of or alignment tolerances associated with the TFLN photonics structure 104. This self-alignment can also allow for relatively relaxed alignment tolerances between the TFLN photonics structure 104 and the silicon photonics structure 102. Additionally, this self-alignment can reduce or eliminate precise alignment tolerances used in current approaches of integrating thin film lithium niobate devices with silicon photonics devices.

In this example, the TFLN photonics structure 104 can also include a handle substrate 110 and an insulator layer 112. The insulator layer 112 represents an oxide or other electrically-insulative material(s). In some embodiments, the insulator layer 112 represents a buried silicon oxide (BOX) layer 112. The handle substrate 110 is positioned over the insulator layer 112. In some embodiments, the handle substrate 110 may represent a composite substrate, such as one formed using a translucent material. The TFLN photonics structure 104 can be encapsulated by an encapsulating layer 108. In some embodiments, the encapsulating layer 108 may be formed using one or more bonding polymer materials. In other embodiments, the encapsulating layer 108 may be formed using one or more optical adhesive materials.

The silicon photonics structure 102 can also include an insulator layer 116, which can be formed using any suitable electrically-insulative material(s). In some embodiments, the insulator layer 116 can be formed using silicon oxide. In various embodiments, the encapsulating layer 108 (which in some cases may be formed using a bonding polymer material or an optical adhesive material) of the TFLN photonics structure 104 may have a refractive index that matches or closely matches a refractive index of the insulator layer 116 (which in some cases may be formed using an oxide layer) of the silicon photonics structure 102. The silicon photonics structure 102 may also include at least one undoped silicon waveguide 118, which can be used to transport optical signals, and at least one silicon nitride (SiN) region 122.

In the illustrated embodiment, at least one of the active devices 128 (such as at least one germanium photodiode) may include a germanium (Ge) region 130, a highly doped n-region 132, and a highly doped p-region 134. The regions 132 and 134 represent areas of a semiconductor substrate or other structure that have been doped with suitable n-type material(s) and p-type material(s), respectively. The silicon photonics structure 102 may also include one or more highly doped silicon regions 144. In some embodiments, the highly doped silicon regions 144 can represent silicide regions. In addition, the silicon photonics structure 102 can include various metal layers 142 that are used for interconnection. The metal layers 142 may be formed using any suitable material(s), such as one or more metals like copper or aluminum. In some embodiments, an interposer structure 106 can be coupled to the silicon photonics structure 102. The interposer structure 106 can include through silicon vias (TSVs) 136 or other electrically-conductive vias that can electrically connect various electrodes of the silicon photonics structure 102 (including the modulator electrodes 124) to solder bumps 138 or other electrical connections. In some cases, the solder bumps 138 can provide electrical and mechanical connections to a module substrate 140, which may be formed using any suitable material(s) and may be used to carry the various components of the photonics device 100.

As shown in FIG. 1B, the photonics device 100′ is similar to the phonics device 100 of FIG. 1A. However, in FIG. 1B, the insulator layer 116 may be completely removed in some embodiments. In this particular arrangement, the insulator layer 116 is completely removed from the silicon photonics structure 102 to form a planarized bonding or other attachment surface on the back side of the silicon phonics structure 102.

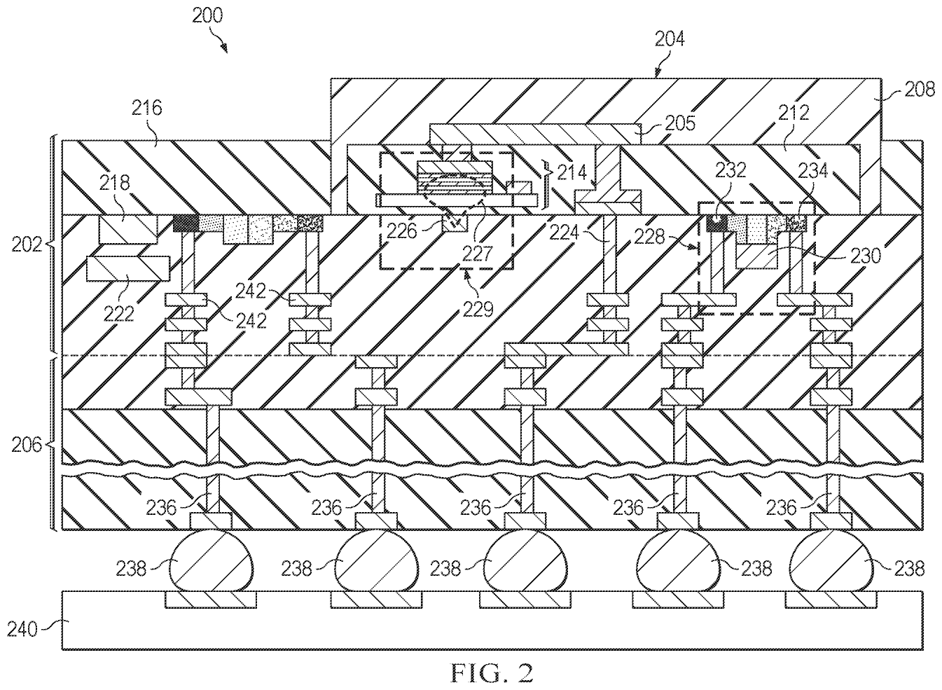

FIG. 2 illustrates an example cross-sectional view of a photonics device 200 having an optically-active photonics structure according to this disclosure. As shown in FIG. 2, the photonics device 200 can include a silicon photonics structure 202 and an optically-active photonics structure 204 that can provide optical gain in the context of the photonics device 200. As an example, the optically-active photonics structure 204 may include at least one indium phosphide (InP) stack 214.

The silicon photonics structure 202 can include at least one waveguide 226 and one or more active devices 228. Each waveguide 226 represents a pathway for optical signals and may be formed using any suitable optical transporting material(s), such as polysilicon, silicon nitride, or silicon oxynitride. The active devices 228 represent one or more semiconductor devices formed in the silicon photonics structure 202, such as one or more germanium-based photodiodes or other suitable semiconductor devices. Each active device 228 is disposed at a specified lateral position in a silicon layer of the silicon photonics structure 202.

The optically-active photonics structure 204 can be bonded or otherwise attached to a backside of the silicon photonics structure 202, enabling colocation of the waveguide(s) 226 and active devices 228 adjacent to the optically-active photonics structure 204. In this way, a relatively high level of integration density can be achieved, compared to current approaches of integrating optically-active photonics devices with silicon photonics devices. The waveguide(s) 226 present in the silicon photonics structure 202 can be optically coupled to the InP stack(s) 214 to form at least one hybrid InP—Si waveguide 229. By including deep-silicon vias (DSVs) 224 or other electrically-conductive vias and the waveguide(s) 226 in the silicon photonics structure 202, an optical mode 227 can receive gain, phase modulation, or amplitude modulation.

The optically-active photonics structure 204 can include a polymer layer 212, such as benzocyclobutene (BCB), and an interconnect layer 205 providing electrical interconnection for the optically-active photonics structure 204. The optically-active photonics structure 204 can be encapsulated in an encapsulating layer 208. In some embodiments, the encapsulating layer 208 may be formed using one or more bonding polymer materials. In other embodiments, the encapsulating layer 208 may be formed using one or more optical adhesive materials.

The silicon photonics structure 202 can include an insulator layer 216, which can be formed using any suitable electrically-insulative material(s). In some embodiments, the insulator layer 216 can be formed using silicon oxide. In various embodiments, the encapsulating layer 208 (which in some cases may be formed using a bonding polymer material or an optical adhesive material) of the optically-active photonics structure 204 may have a refractive index that matches or closely matches a refractive index of the insulator layer 216 (which in some cases may be formed using an oxide layer) of the silicon photonics structure 202. The silicon photonics structure 202 may also include at least one undoped silicon waveguide 218, which can be used to transport optical signals, and at least one silicon nitride region 222.

In the illustrated embodiment, at least one of the active devices 228 (such as at least one germanium photodiode) may include a germanium region 230, a highly doped n-region 232, and a highly doped p-region 234. The regions 232 and 234 represent areas of a semiconductor substrate or other structure that have been doped with suitable n-type material(s) and p-type material(s), respectively. The silicon photonics structure 202 may also include one or more highly doped silicon regions 244. In some embodiments, the highly doped silicon regions 244 can represent silicide regions. In addition, the silicon photonics structure 202 can include various metal layers 242 that are used for interconnection. The metal layers 242 may be formed using any suitable material(s), such as one or more metals like copper or aluminum. In some embodiments, an interposer structure 206 can be coupled to the silicon photonics structure 202. The interposer structure 206 can include through silicon vias 236 or other electrically-conductive vias that can electrically connect various electrodes of the silicon photonics structure 202 (including the deep-silicon vias 224) to solder bumps 238 or other electrical connections. In some cases, the solder bumps 238 can provide electrical and mechanical connections to a module substrate 240, which may be formed using any suitable material(s) and may be used to carry the various components of the photonics device 200.

Although FIGS. 1A, 1B, and 2 illustrate examples of cross-sectional views of photonics devices 100, 100′, 200, various changes may be made to FIGS. 1A, 1B, and 2. For example, each photonics device 100, 100′, 200 may include any suitable number of each of the illustrated components in any suitable arrangement. Also, one or more components of each photonics device 100, 100′, 200 may be omitted or one or more additional components may be added according to particular needs. In addition, the various sizes, shapes, and dimensions of the photonics devices 100, 100′, 200 and their individual components can vary as needed or desired.

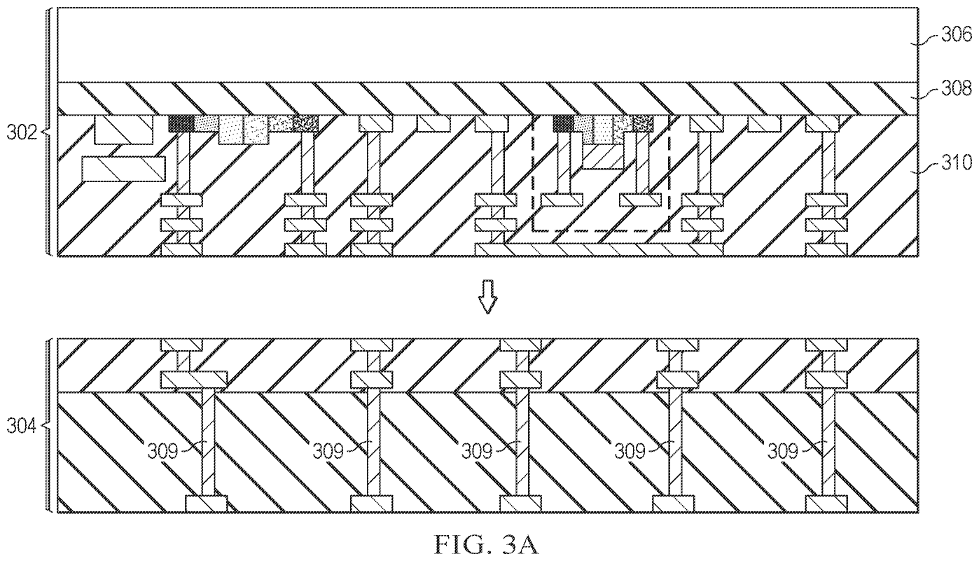

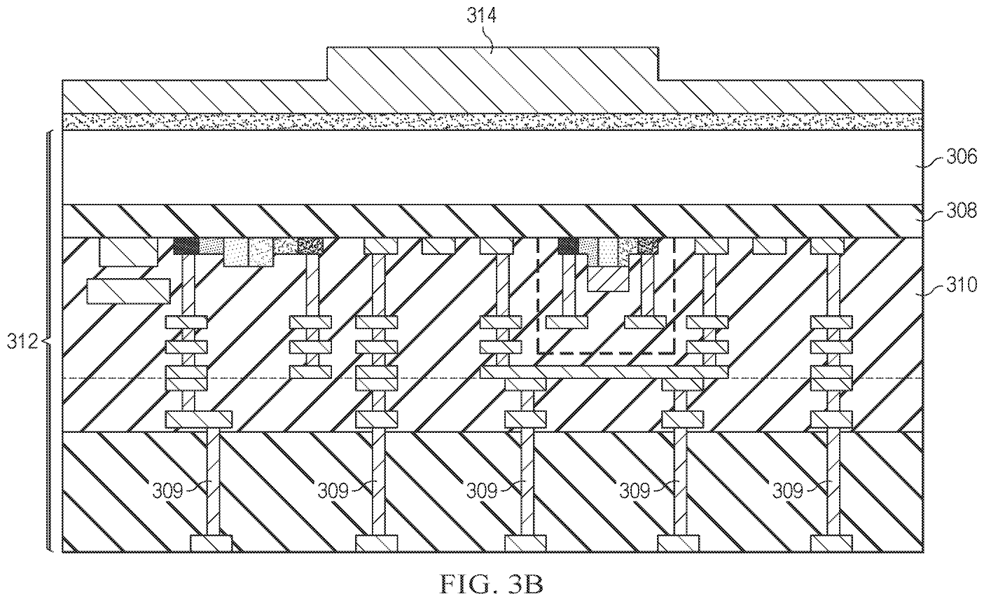

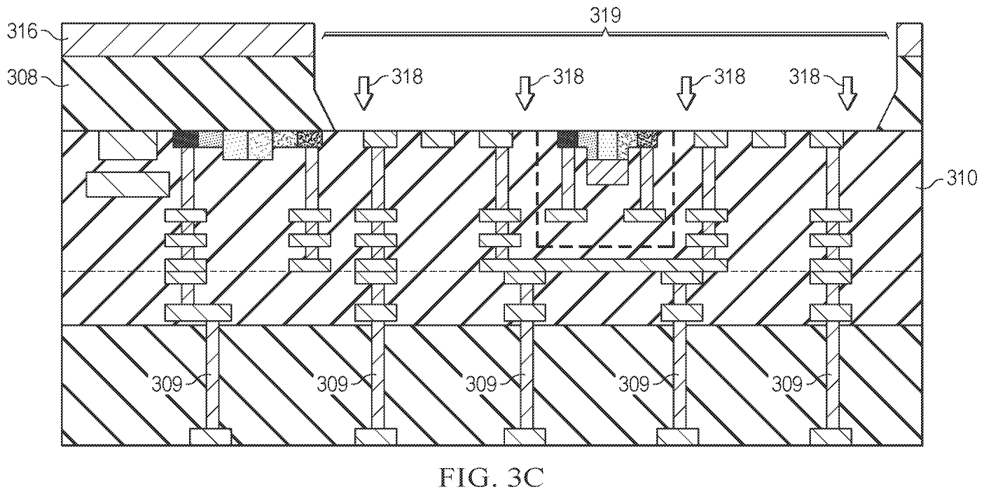

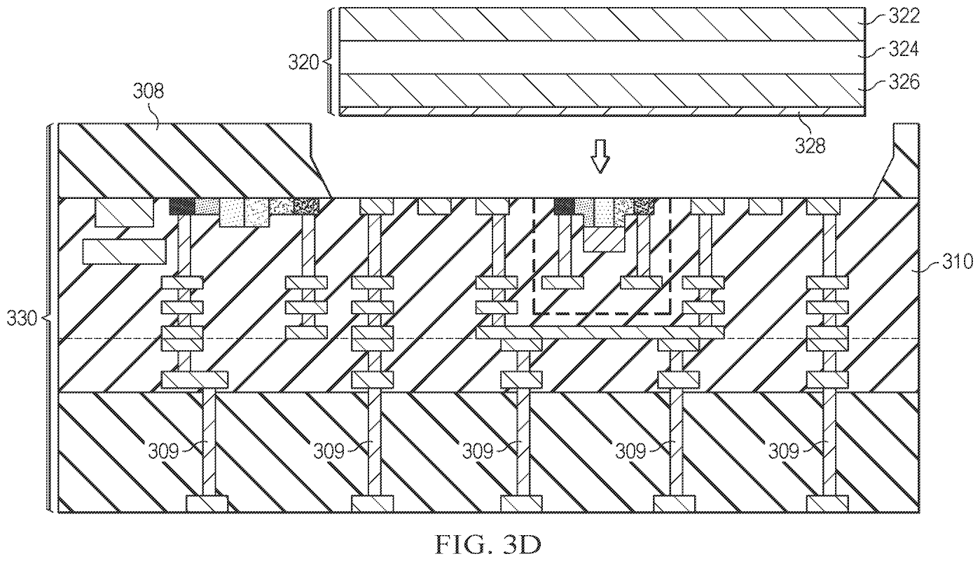

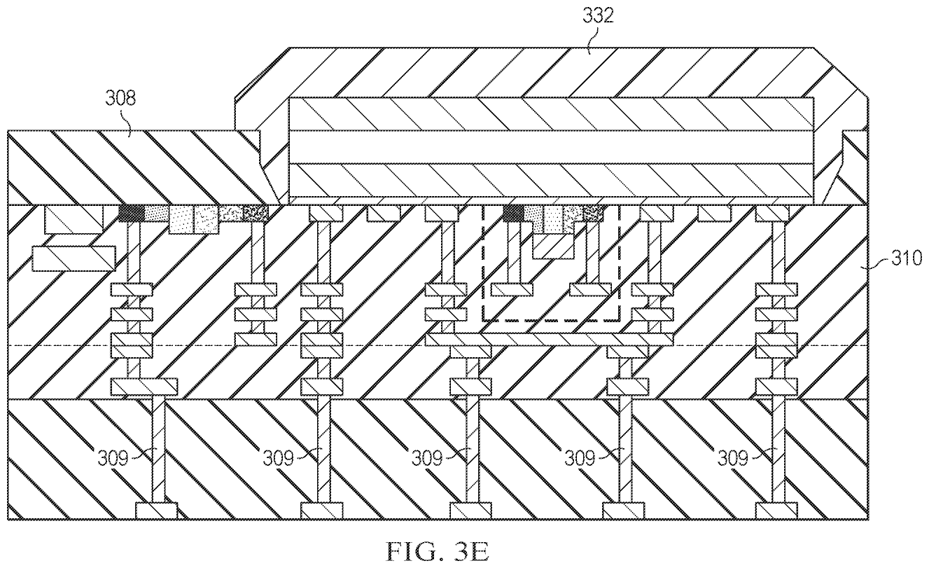

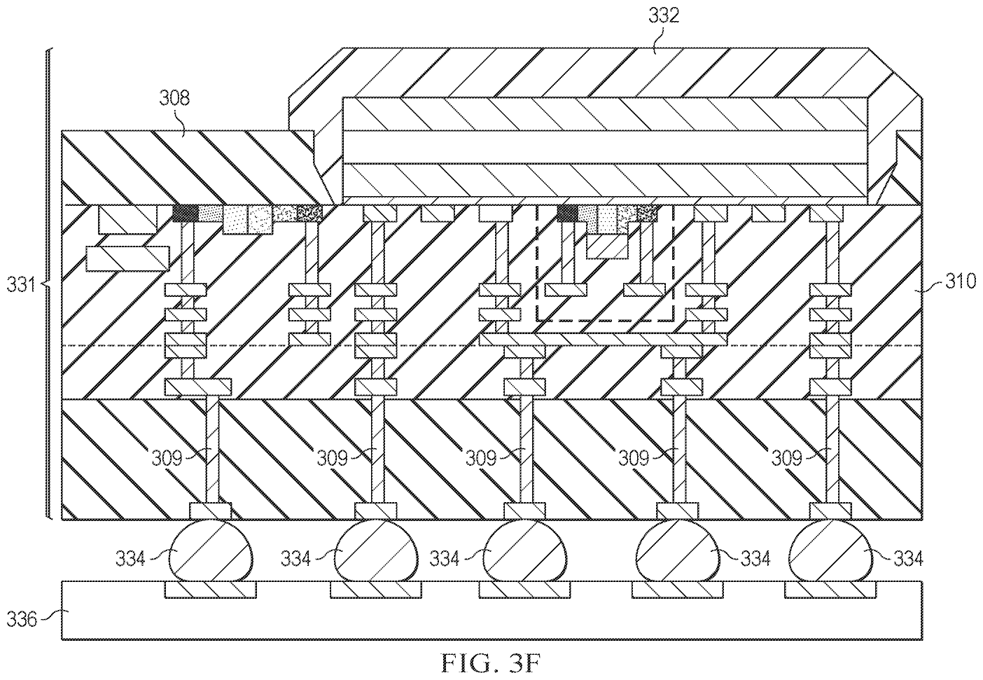

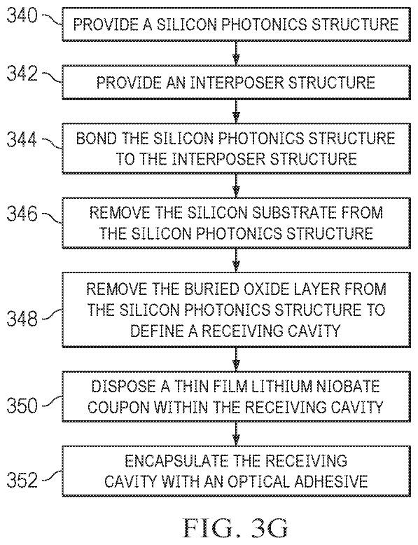

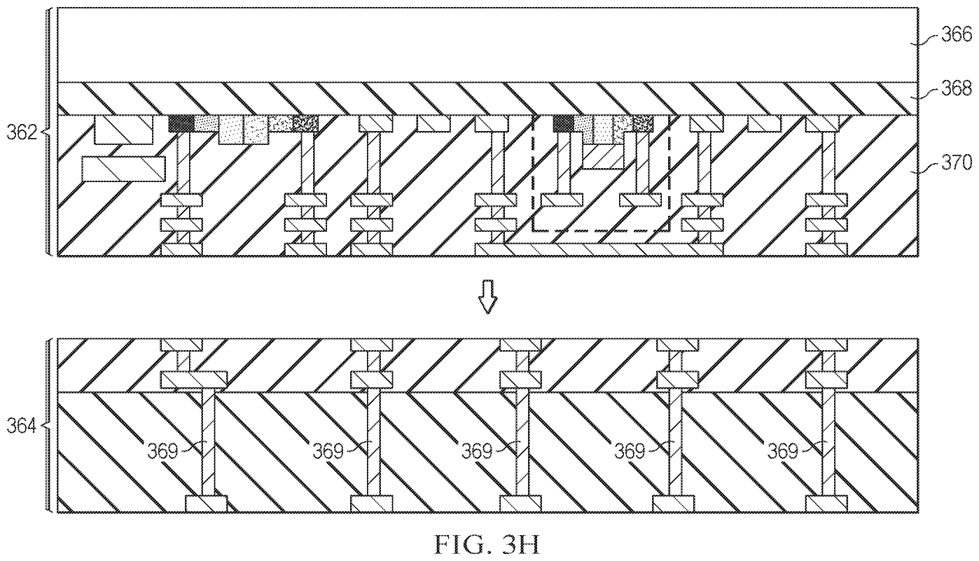

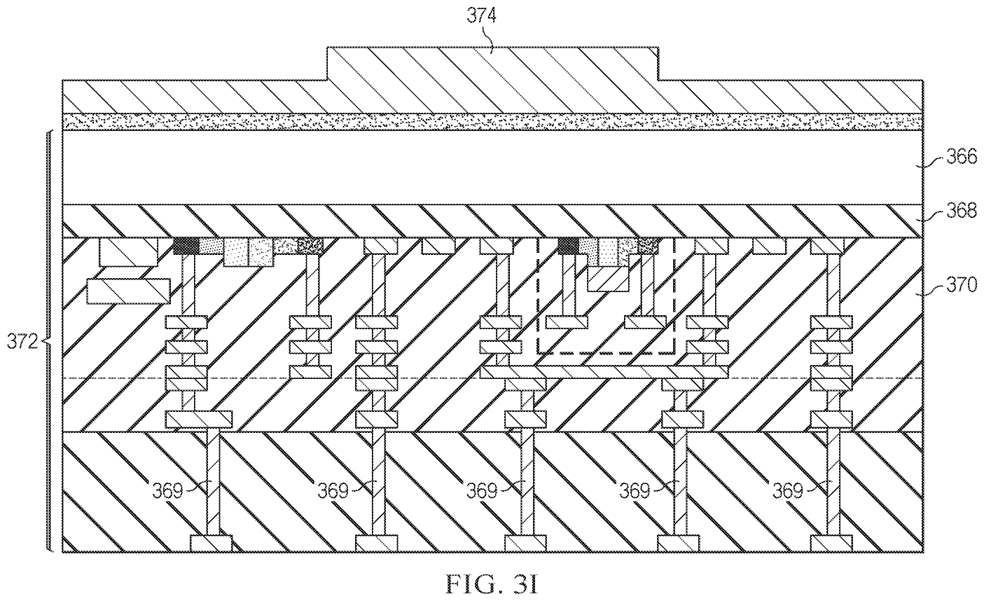

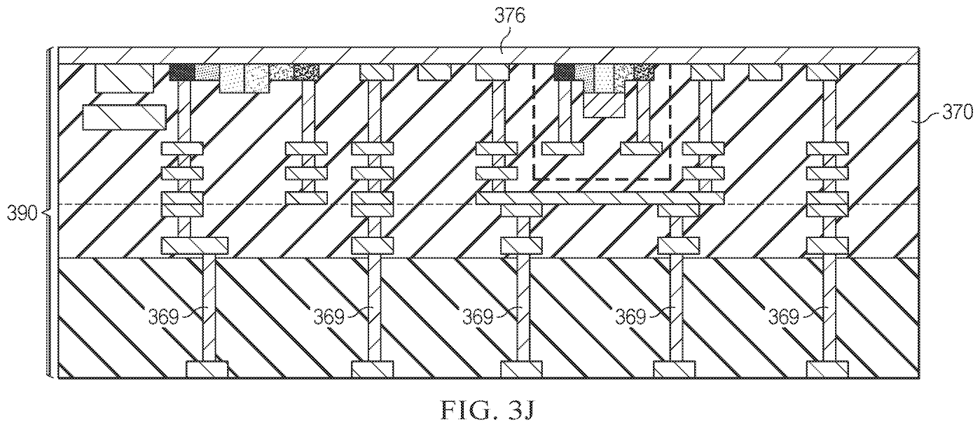

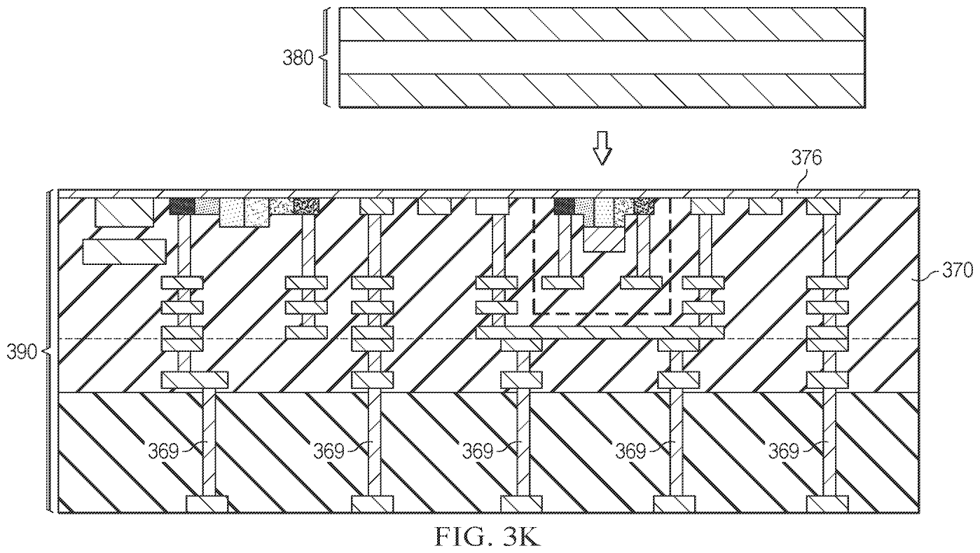

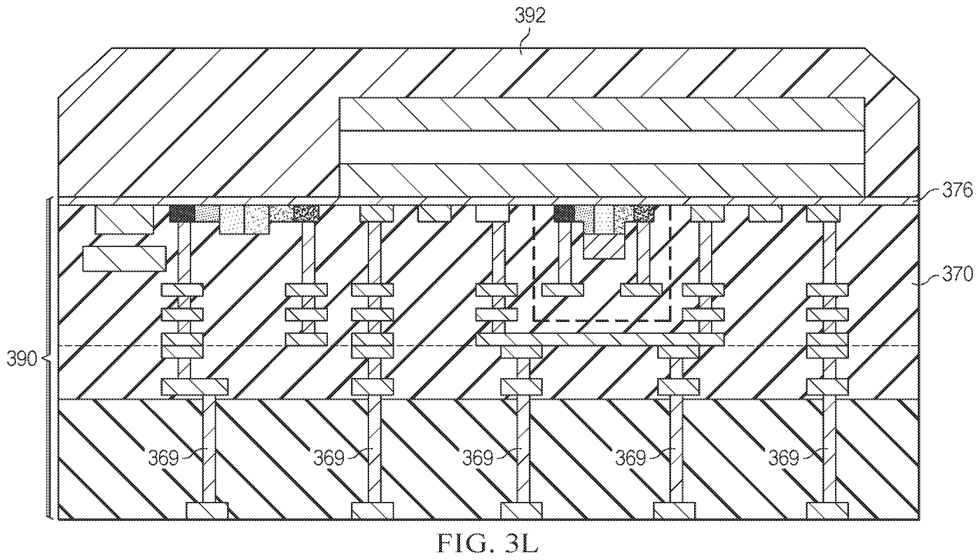

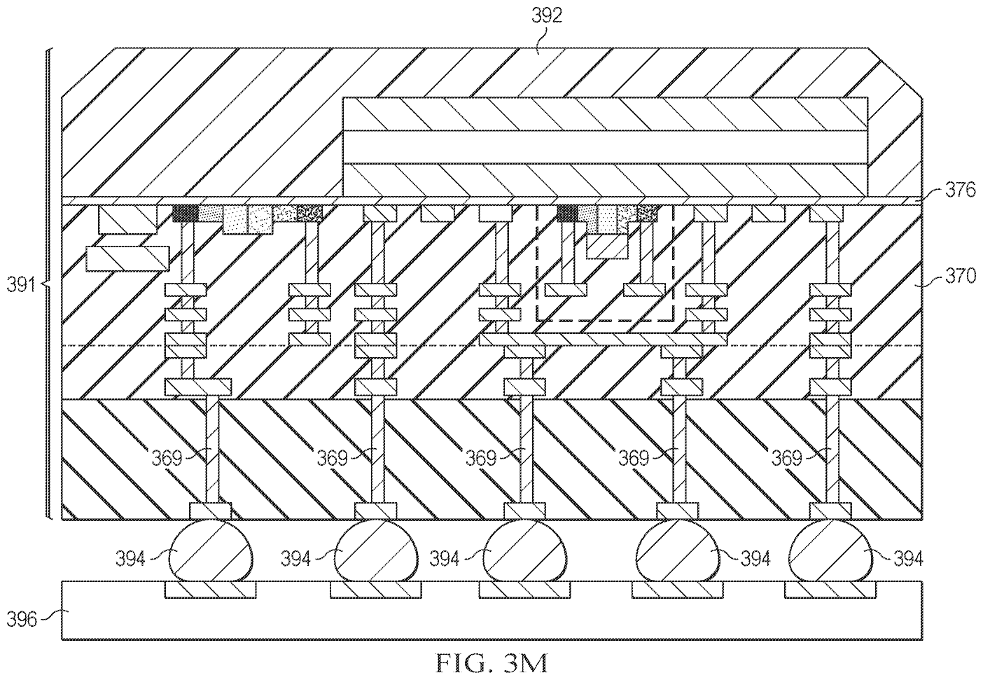

FIGS. 3A through 3M illustrate example techniques for fabricating photonics stacks according to this disclosure. More specifically, FIGS. 3A through 3F illustrate an example technique for fabricating a first photonics stack, FIG. 3G illustrates an example method for fabricating a photonics stack, and FIGS. 3H through 3M illustrate an example technique for fabricating a second photonics stack.

As shown in FIG. 3A, a fully-processed silicon photonics wafer 302 and an interposer wafer 304 can be bonded or otherwise attached. As will be evident to one of skill in the art, the silicon photonics wafer 302 can be fabricated and then flipped so that the active region(s) of the silicon photonics wafer 302 face(s) the interposer wafer 304 (or vice versa). The silicon photonics wafer 302 can include a silicon substrate 306, an oxide layer 308 (such as a buried oxide layer), and a silicon layer 310 (such as an epitaxial silicon layer) with active and passive devices. In some embodiments, the interposer wafer 304 may include through silicon vias 309 or other electrically-conductive vias. In other embodiments, the interposer wafer 304 may not include TSVs, and the TSVs or other electrically-conductive vias can be formed in the silicon photonics wafer 302. The interposer wafer 304 can be used to provide mechanical support, and the through silicon vias 309 or other electrically-conductive vias can be used for electrical connection involving various electrodes in the silicon photonics wafer 302.

As shown in FIG. 3B, the silicon photonics wafer 302 and the interposer wafer 304 can be bonded or otherwise attached to form a mechanically-inseparable and electrically-connected stack 312. FIG. 3B also illustrates the removal of the silicon substrate 306 of the silicon photonics wafer 302, such as by using a chemo-mechanical polishing (CMP) process 314. Note, however, that any other suitable process may be used to remove the silicon substrate 306, such as grinding or other suitable processes. In this example embodiment, the removal process for the silicon substrate 306 can stop at an interface between the oxide layer 308 and the silicon substrate 306.

As shown in FIG. 3C, a photoresist layer 316 is deposited and patterned, and a plasma etch process or other suitable etch process 318 is utilized to open a receiving window 319 in the oxide layer 308. The etch process 318 removes at least a portion of the oxide layer 308 in at least one location to form the receiving window 319. In some embodiments, a thin oxide layer remains in the receiving window 319 after the etch process 318, which may have a thickness of, for example, less than about 100 nanometers. However, other values for the thickness of the remaining oxide layer can be used. Also, in some embodiments, removing the illustrated portion of the oxide layer 308 can be performed by a preferential etching process, such as a reactive ion etch, followed by a buffered oxide etching process. As illustrated in FIG. 3C, the photoresist layer 316 is used to mask the rest of the structure during the etching of the receiving window 319.

As shown in FIG. 3D, a bonding or other attachment process for attaching one or more TFLN chiplets 320 to a resulting photonics stack 330 is shown. As illustrated in FIG. 3D, prior to attachment, a TFLN wafer may be coated with a bonding polymer layer 328 and diced into TFLN chiplets 320. In some embodiments, the thickness of the bonding polymer layer 328 can be, for example, about 40 nanometers to about 100 nanometers. However, other suitable thickness values can be used. In various embodiments, the bonding polymer layer 328 can include any suitable polymer material(s), such as benzocyclobutene. Each TFLN chiplet 320 can include a substrate 322, a dielectric layer 324 formed using at least one dielectric material (such as silicon oxide), a thin film lithium niobate layer 326, and the bonding polymer layer 328. In some embodiments, each TFLN chiplet 320 can have a length of, for example, about 1 millimeter to about 2 millimeters. However, other suitable lengths can be used. In the embodiment shown in FIG. 3D, the TFLN chiplet 320 is selected and placed into the receiving window 319, and the TFLN chiplet 320 is subsequently compression bonded or otherwise attached to the photonics stack 330. Note, however, that the TFLN chiplet 320 may be bonded to the photonics stack 330 without the bonding polymer layer 328 in other embodiments, such as through the use of direct bonding.

At this point, there may be no electrical connection between the TFLN chiplet 320 and the photonics stack 330. In some embodiments, a thin layer of oxide (such as a thin portion of the oxide layer 308) may remain in the receiving window 319. However, this thin layer of oxide may not impact the electric fields subsequently established, at least to any significant extent. The alignment tolerance for aligning the TFLN chiplet 320 to the photonics stack 330 can be relatively relaxed. For example, in some embodiments, the alignment tolerance can be ±5 microns. These relatively relaxed alignment tolerances are attainable because, in the disclosed systems and methods, modulator electrodes and waveguides are formed in the silicon photonics structure, so the resulting optical and electrical fields are aligned. This can allow the TFLN chiplet 320 to have relatively relaxed alignment tolerance with respect to waveguides, since misalignment of the TFLN chiplet 320 to the photonics stack 330 does not impact the alignment of the optical and electrical fields, again at least to any significant extent.

As shown in FIG. 3E, the receiving window 319 is encapsulated, such as with a near infrared (NIR) transparent polymer or other polymer 332 that fills the receiving window 319 and locations between sidewalls of the TFLN chiplet 320 and the oxide layer 308. In some embodiments, the refractive index of the polymer 332, which can also be referred to as an optical adhesive, can match or closely match that of the oxide layer 308. As a particular example, both may have a refractive index of about 1.4 to about 1.6. As shown in FIG. 3F, solder bumps 334 can be formed on the bonded wafer 331. In some cases, the solder-bumped wafer 331 may be diced or otherwise split and connected to a module substrate 336.

It should be appreciated that the specific steps illustrated in FIGS. 3A through 3F provide a particular technique for fabricating a first silicon photonics stack according to this disclosure. However, other sequences of steps may also be performed according to other embodiments of this disclosure. For example, other embodiments of this disclosure may perform the steps outlined above in a different order. Moreover, any or all of the individual steps illustrated in FIGS. 3A through 3F may include multiple sub-steps that can be performed in various sequences as appropriate to the individual step(s). Furthermore, additional steps may be added or steps may be removed depending on the particular applications. One of ordinary skill in the art would recognize many variations, modifications, and alternatives.

As shown in FIG. 3G, a method of fabricating a photonics stack includes providing a silicon photonics structure, such as one that includes a silicon substrate, an oxide layer, and a silicon layer with one or more active devices, at step 340. As illustrated in FIG. 1A, for example, the silicon photonics structure 102 can include one or more active devices 128, such as one or more germanium photodiodes having one or more germanium regions 130, one or more highly doped n-regions 132, and one or more highly doped p-regions 134. The silicon photonics structure 102 may also include highly doped silicon regions 144, such as silicide regions. The silicon photonics structure 102 may further include polysilicon, silicon nitride, silicon oxynitride, or other dielectric material(s) suitable for optical waveguide formation. The silicon photonics structure 102 can include various metal and conductive thin-film layers that are used for interconnection.

An interposer structure is provided at step 342, and the silicon photonics structure is bonded or otherwise attached to the interposer structure at step 344. As illustrated in FIG. 1A, for example, the interposer structure 106 can include TSVs 136 or other electrically-conductive vias used for connecting various electrodes in the silicon photonics structure 102 to solder bumps. The silicon substrate is removed from the silicon photonics structure at step 346, and at least one portion of a buried oxide layer or other oxide layer is removed from the silicon photonics structure to define a receiving cavity at step 348. In some embodiments, removing the silicon substrate 306 is performed using a chemical mechanical polishing process. Also, in some embodiments, removing the buried oxide layer or other oxide layer 308 is performed using a reactive ion etch followed by a buffered oxide etch.

A thin film lithium niobate coupon (such as a TFLN chiplet 320) is disposed within the receiving cavity at step 350, and the receiving cavity is encapsulated with an optical adhesive at step 352. In some embodiments, the thin film lithium niobate coupon can include an insulator layer, such as a buried silicon oxide layer, and a handle substrate. The encapsulating adhesive may have a refractive index that matches or closely matches a refractive index of the insulator layer of the silicon photonics structure 102.

It should be appreciated that the specific steps illustrated in FIG. 3G provide a particular technique for fabricating a silicon photonics stack according to this disclosure. However, other sequences of steps may also be performed according to other embodiments of this disclosure. For example, other embodiments of this disclosure may perform the steps outlined above in a different order. Moreover, any or all of the individual steps illustrated in FIG. 3G may include multiple sub-steps that can be performed in various sequences as appropriate to the individual step(s). Furthermore, additional steps may be added or steps may be removed depending on the particular applications. One of ordinary skill in the art would recognize many variations, modifications, and alternatives.

As shown in FIG. 3H, a fully-processed silicon photonics wafer 362 and an interposer wafer 364 can be bonded or otherwise attached. As will be evident to one of skill in the art, the silicon photonics wafer 362 can be fabricated and then flipped so that the active region(s) of the silicon photonics wafer 362 face(s) the interposer wafer 364 (or vice versa). The silicon photonics wafer 362 can include a silicon substrate 366, an oxide layer 368 (such as a buried oxide layer), and a silicon layer 370 (such as an epitaxial silicon layer) with active and passive devices. In some embodiments, the interposer wafer 364 may include through silicon vias 369 or other electrically-conductive vias. In other embodiments, the interposer wafer 364 may not include TSVs, and the TSVs or other electrically-conductive vias can be formed in the silicon photonics wafer 362. The interposer wafer 364 can be used to provide mechanical support, and the through silicon vias 369 or other electrically-conductive vias can be used for electrical connection involving various electrodes in the silicon photonics wafer 362.

As shown in FIG. 3I, the silicon photonics wafer 362 and the interposer wafer 364 can be bonded or otherwise attached to form a mechanically-inseparable and electrically-connected stack 372. FIG. 3I also illustrates the removal of the silicon substrate 366 of the silicon photonics wafer 362, such as by using a chemo-mechanical polishing process 374. Note, however, that any other suitable process may be used to remove the silicon substrate 366, such as grinding or other suitable processes. In this example embodiment, the silicon substrate 366 is removed by the process 374, and the entire oxide layer 368 may also be removed from the silicon photonics wafer 362.

As shown in FIG. 3J, a bonding polymer layer 376 can be spin-coated or otherwise deposited onto a resulting photonics stack 390. As shown in FIG. 3K, the bonding polymer layer 376 can be used to bond or otherwise attach the photonics stack 390 with a thin film lithium niobate chiplet 380. In some embodiments, the thickness of the bonding polymer layer 376 can be, for example, about 40 nanometers to about 100 nanometers. However, other suitable thickness values can be used. In various embodiments, the bonding polymer layer 376 can include any suitable polymer material(s), such as benzocyclobutene. In FIG. 3K, the TFLN chiplet 380 (or wafer) can be bonded with or otherwise attached to the photonics stack 390 using the bonding polymer layer 376. Note, however, that the TFLN chiplet 380 may be bonded to the photonics stack 390 without the bonding polymer layer 376 in other embodiments, such as through the use of direct bonding. In some embodiments, the TFLN chiplet 380 can have a length of, for example, about 1 millimeter to about 2 millimeters. However, other suitable lengths can be used.

As shown in FIG. 3L, the bonded photonics structure is encapsulated, such as with a near infrared transparent polymer or other polymer 392. In some embodiments, the refractive index of the polymer 392 can be, for example, about 1.4 to about 1.6. Also, in some embodiments, the bonded photonics structure may be encapsulated, such as by using an inorganic dielectric material like silicon dioxide. As shown in FIG. 3M, solder bumps 394 can be formed on the bonded wafer 391. In some cases, the solder-bumped wafer 391 may be diced or otherwise split and connected to a module substrate 396.

It should be appreciated that the specific steps illustrated in FIGS. 3H through 3M provide a particular technique for fabricating a second silicon photonics stack according to this disclosure. However, other sequences of steps may also be performed according to other embodiments of this disclosure. For example, other embodiments of this disclosure may perform the steps outlined above in a different order. Moreover, any or all of the individual steps illustrated in FIGS. 3H through 3M may include multiple sub-steps that can be performed in various sequences as appropriate to the individual step(s). Furthermore, additional steps may be added or steps may be removed depending on the particular applications. One of ordinary skill in the art would recognize many variations, modifications, and alternatives.

Although FIGS. 3A through 3M illustrate examples of techniques for fabricating photonics stacks, various changes may be made to FIGS. 3A through 3M. For example, each photonics device may include any suitable number of each of the illustrated components in any suitable arrangement. Also, one or more components of each photonics device may be omitted or one or more additional components may be added according to particular needs. Further, the various sizes, shapes, and dimensions of the photonics devices and their individual components can vary as needed or desired. In addition, any other suitable techniques may be used to fabricate each photonics device.

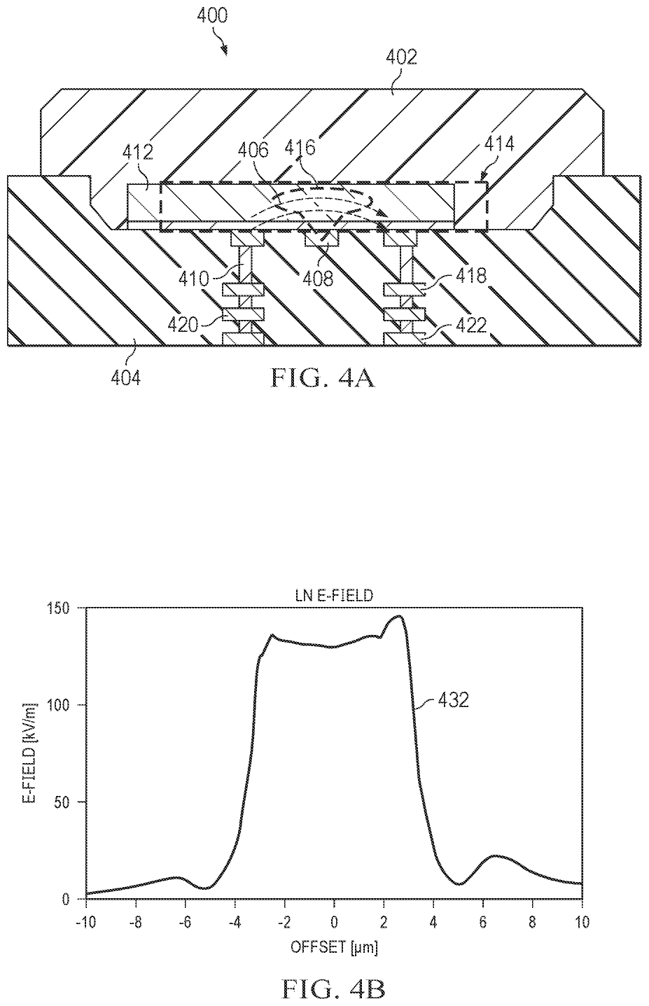

FIGS. 4A and 4B illustrate example views of a waveguide and modulator electrodes in a silicon photonics structure of a photonics device 400 and related details according to this disclosure. As shown in FIG. 4A, the photonics device 400 can include (i) a TFLN chip 412 encapsulated by a transparent polymer 402 and (ii) a silicon photonics structure 404 having a waveguide 408. The waveguide 408 is adjacent to modulator electrodes 410. The silicon photonics structure 404 can also include multiple metal layers, such as a “metal 1” layer 418, a “metal 2” layer 420, and a “metal 3” layer 422. The metal layers 418, 420, 422 can be used for interconnection and to provide electrical drive to the modulator electrodes 410. As can be seen in FIG. 4A, the waveguide 408 and a portion of the modulator electrodes 410 can be disposed in a common plane, and the TFLN chip 412 can be disposed in an adjacent plane.

The modulator electrodes 410 can be in close proximity to the waveguide 408 and can be used to generate an electric field 406 that is present in the TFLN chip 412. As can be seen here, a resulting optical mode 416 and the electric field 406 are aligned because the modulator electrodes 410 and the waveguide 408 are formed in the silicon photonics structure 404. If the TFLN chip 412 shifts to a position 414, such as due to misalignment, the optical mode 416 and the electrical field 406 would still stay aligned. Therefore, the inherent self-alignment of the electro-optical structure in the disclosed systems and methods can eliminate impairments due to in-plane misalignment that exists in current approaches. These impairments can include, for example, enhanced losses due to increased metal to optical mode overlap, reduction of effective index modulation due to optical mode and electric field misalignment, and polarization and intensity modulation due to electric field vector mismatch that could transform input transverse electric and transverse magnetic (TE/TM) modes into mixed TE+TM modes. As an example, using a prior approach, a misalignment of 0.5 microns between a TFLN chip and a silicon photonics structure can produce a loss of about 2.66 dB/cm. In contrast, using embodiments of this disclosure, a misalignment of 0.5 microns between the TFLN chip 412 and the silicon photonics structure 404 may result in no losses.

As shown in FIG. 4B, a graph illustrates a curve 432 identifying electric field strength as a function of misalignment offset for the photonics structure in FIG. 4A. As can be seen here, if the TFLN chip 412 is centered on the waveguide 408, this would result in a misalignment offset of zero in FIG. 4B. As can be seen in FIG. 4B, the electric field strength is relatively high and constant at locations for which the misalignment offset is within ±5 microns of the location of the waveguide 408. Thus, the electric field strength is shown to be approximately 140 KV/m for misalignment offset values from −5 microns to +5 microns around the position of the waveguide 408.

Although FIGS. 4A and 4B illustrate examples of views of a waveguide 408 and modulator electrodes 410 in a silicon photonics structure 404 of a photonics device 400 and related details, various changes may be made to FIGS. 4A and 4B. For example, the photonics device 400 may include any suitable number of each of the illustrated components in any suitable arrangement. Also, the various sizes, shapes, and dimensions of the photonics device and its individual components can vary as needed or desired. In addition, the graph in FIG. 4B is for illustration only, and the electric field strength can easily vary based on the specific implementation of the photonics device 400.

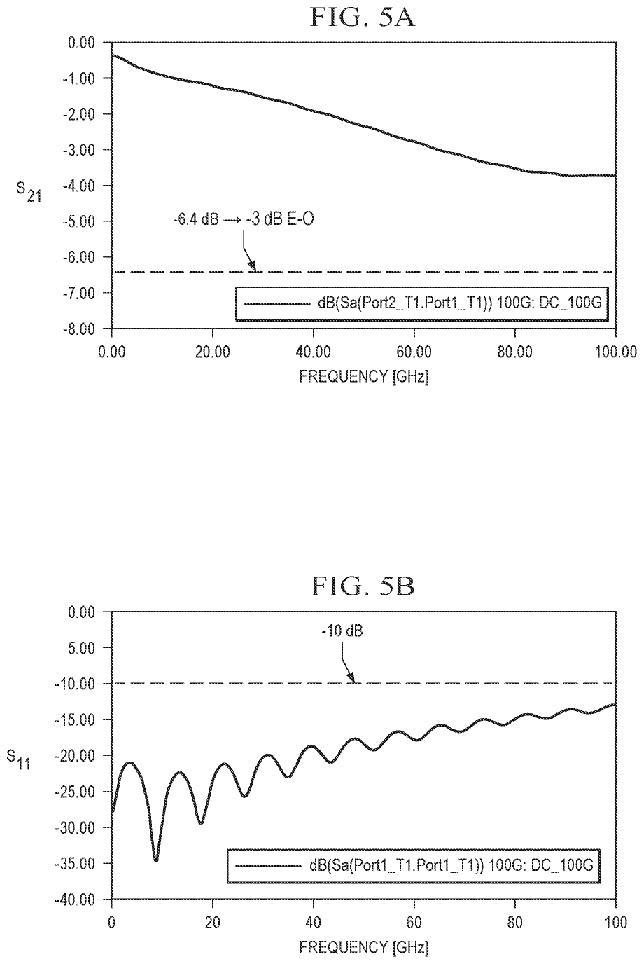

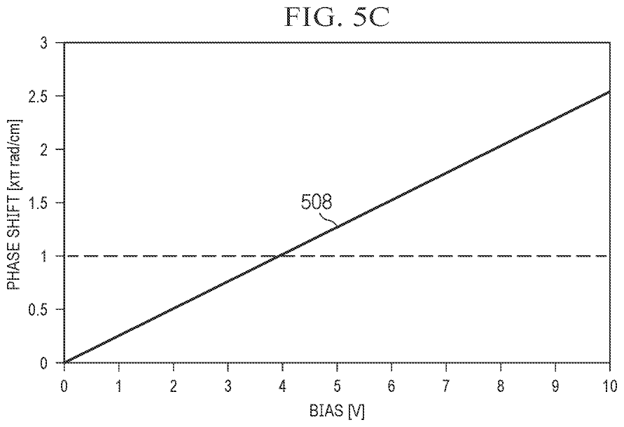

FIGS. 5A through 5C illustrate example operational characteristics of a silicon photonics modulator according to this disclosure. More specifically, FIG. 5A includes a graph plotting a forward voltage gain coefficient (S₂₁) as a function of frequency for a one-centimeter modulator arm length. The S₂₁ coefficient represents the electro-optic frequency response of the modulator. As can be seen in FIG. 5A, the S₂₁ coefficient has a relatively high value across the frequency spectrum, which is beneficial for the performance of the modulator. FIG. 5B includes a graph plotting an input port reflection (S₁₁) coefficient as a function of frequency for the modulator of FIG. 5A. The S₁₁ coefficient represents the input reflection of an optical signal provided to the modulator. As can be seen in FIG. 5B, the S₁₁ coefficient has a relatively low value across the frequency spectrum. A relatively low value for the S₁₁ coefficient can improve power efficiency and group-delay variations due to reflection. These graphs show that the modulation bandwidth of the modulator can go up to 100 GHz.

FIG. 5C includes a graph plotting a phase shift as a function of bias voltage for the modulator of FIG. 5A. As illustrated in FIG. 5C, as the bias voltage is increased, the phase shift increases linearly along a line 508, eventually reaching a phase shift of π radian/cm at a bias voltage of about 4 volts. The phase shift as a function of bias voltage relationship is a measure of electro-optic modulation efficiency of a device. In particular, devices are more efficient when lower voltages can be used to reach the π radian phase shift per unit length. As can be seen in FIG. 5C, the phase shift reaches a value of π radian/cm at a relatively low value of bias voltage.

Although FIGS. 5A through 5C illustrate examples of operational characteristics of a silicon photonics modulator, various changes may be made to FIGS. 5A through 5C. For example, the operational characteristics shown in FIGS. 5A through 5C are examples only and do not limit this disclosure to any particular implementation or operational characteristics of a silicon photonics modulator. As a particular example, the value of modulation efficiency for a silicon photonics modulator is not limited to the results shown in FIG. 5C and, in various embodiments, may be better than that shown in the graph of FIG. 5C.

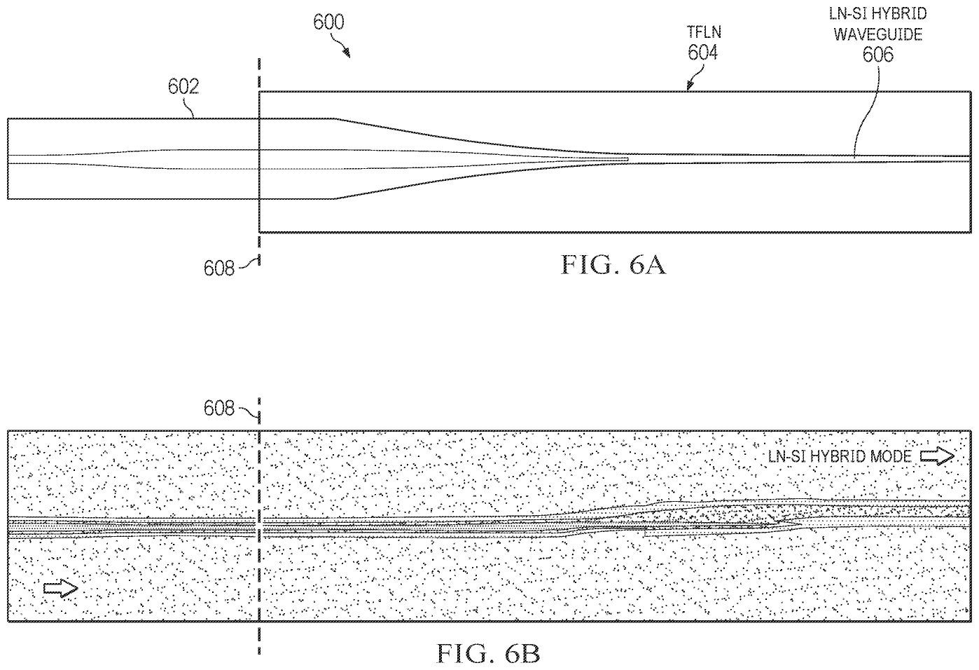

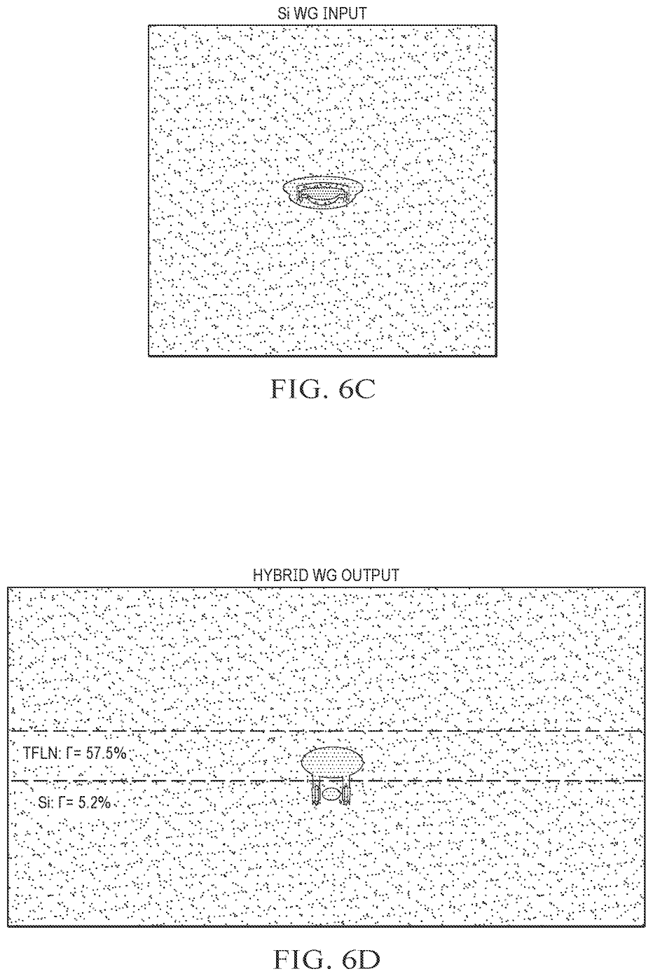

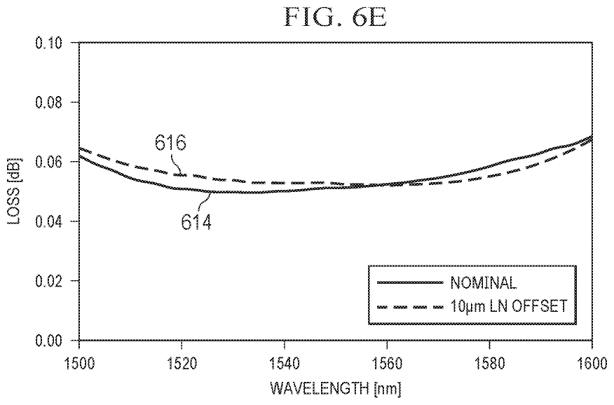

FIGS. 6A through 6E illustrate an example optical waveguide 600 and associated operational features according to this disclosure. The optical waveguide 600 here may for example, be used in one or more of the photonics devices described above, such as in the silicon photonics structure 202. As shown in FIG. 6A, a plan view of the optical waveguide 600 is shown, where the optical waveguide 600 can include a silicon waveguide 602, a LN-Si hybrid waveguide 604, and a TFLN layer 606. In this example, the silicon waveguide 602 is positioned underneath the LN-Si hybrid waveguide 604, and an edge of the TFLN layer 606 is identified by a position 608. In the illustrated embodiment, a four-stage tapered design is used in regions in which the waveguide 600 expands and tapers.

FIG. 6B illustrates an example optical field intensity in a propagational cross-section of the waveguide of FIG. 6A. As can be seen in FIG. 6B, the optical field intensity is greatest in the central portion of FIG. 6B and is significantly weaker along the top and bottom edges of FIG. 6B. FIG. 6C illustrates an example cross-sectional view of the optical mode input into the silicon waveguide 602, and FIG. 6D illustrates an example cross-sectional view of the optical mode output by the hybrid waveguide 604. As illustrated in FIGS. 6C and 6D, embodiments of this disclosure are capable of overcoming modal mismatch between the silicon waveguide and hybrid waveguide modes and the index mismatch caused by the interface of an encapsulation polymer (with a refractive index n of about 1.44 to about 1.45) and lithium niobate (with a refractive index n of about 2.2).

FIG. 6E illustrates waveguide loss as a function of wavelength for differing amounts of waveguide misalignment. As shown in FIG. 6E, an example of a precisely-aligned waveguide is illustrated by a curve 614, which is the nominal case. For the precisely-aligned waveguide, the waveguide loss varies from about 0.06 dB at a wavelength of 1500 nanometers, decreases slightly at a wavelength of 1560 nanometers, and increases to about 0.07 dB at a wavelength of 1600 nanometers. A curve 616 illustrates an example of a misalignment of a TFLN chiplet with respect to a silicon waveguide by 10 microns (such as ±5 microns of misalignment). As can be seen from the difference between the curves 614 and 616, the difference in waveguide loss is less than 0.01 dB, regardless of the value of the misalignment between the silicon waveguide and the TFLN chiplet over the entire wavelength range.

In some embodiments, a PIN diode can be introduced into the silicon waveguide 602 in order to increase the power handling capacity of the silicon waveguide 602. The introduction of the PIN diode can be accomplished since active devices can be collocated with the TFLN using the disclosed systems and methods, whereas the introduction of a PIN diode into a waveguide is rendered difficult if not prohibited using conventional techniques.

Although FIGS. 6A through 6E illustrate one example of an optical waveguide 600 and associated operational features, various changes may be made to FIGS. 6A through 6E. For example, various sizes, shapes, and dimensions of the optical waveguide 600 and its individual components can vary as needed or desired. Also, the operational features shown in FIGS. 6B through 6E are examples only and do not limit this disclosure to any particular implementation or operational characteristics of an optical waveguide.

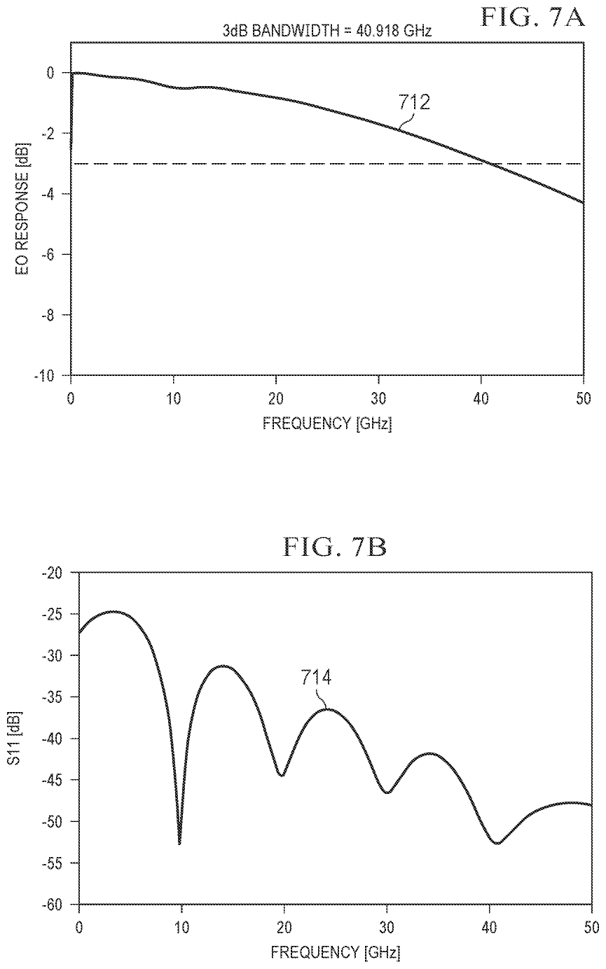

FIGS. 7A and 7B illustrate example characteristics of a silicon photonics modulator according to this disclosure. In some embodiments, the utilization of multi-layer metal layers in a photonics structure can enable advanced microwave engineering techniques. For example, FIG. 7A illustrates a graph with a curve 712 plotting response as a function of frequency for a silicon push-pull modulator, which may be implemented as shown in FIGS. 1A and 1n which the silicon push-pull modulator may utilize multi-layer metal layers.

FIG. 7B illustrates a graph with a curve 714 plotting the input port reflection coefficient as a function of frequency for the silicon push-pull modulator of FIG. 1A, where the silicon push-pull modulator again utilizes multi-layer metal layers. As shown in FIGS. 7A and 7B, a 3 dB bandwidth can be increased to 40 GHz, which represents a 30% increase over the bandwidth that can be achieved using conventional techniques. Moreover, it is possible for the multi-layer metals in a silicon photonics device to be employed for group velocity matching between electrical signal propagation along a co-planar waveguide and optical field propagation in the hybrid waveguide.

Although FIGS. 7A and 7B illustrate examples of characteristics of a silicon photonics modulator, various changes may be made to FIGS. 7A and 7B. For example, the characteristics shown in FIGS. 7A and 7B are examples only and do not limit this disclosure to any particular implementation or characteristics of a silicon photonics modulator.

In some embodiments, the disclosed systems and methods for integration of nonlinear optical materials in silicon photonics can enable significant mitigation of mode mismatch losses between single-mode waveguides and modulator hybrid modes. In some cases, this may allow for greater than 98% coupling efficiency with less than 0.1 dB excess loss between silicon waveguides and modulator blocks in the TFLN, even in the presence of significant (such as ±10 micron) misalignment. Moreover, in various embodiments, the disclosed systems and methods may allow for the integration of nonlinear optical materials in silicon photonics using existing silicon photonics fabrication flows, thereby allowing reuse of existing photonics process development kits (PDKs). Further, the disclosed systems and methods can enable high-density, multi-functional photonic integrated circuit (PIC) devices. For example, these devices can include, but are not limited to, fiber and laser interface devices, polarization management devices, nonlinear loss-managed waveguides, waveguide transitions, coherent receivers, photodetectors, digital silicon modulators, or the like. In some embodiments, application-specific PICs can include more than three hundred devices in less than a 0.1 cm³ volume. This contrasts with the device density characteristic of discrete optical devices implementing the same circuits, which today may typically occupy a space 100,000 times larger than the 0.1 cm³ volume utilized by circuits implemented according to embodiments of this disclosure. One of ordinary skill in the art will appreciate that other modifications to the systems and methods of this disclosure may be made for implementing various applications of the systems and methods to support the integration of thin film nonlinear optical materials in silicon photonics without departing from the scope of this disclosure.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in this disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A photonics device comprising:
a silicon waveguide structure disposed in a first plane;
a plurality of modulator electrodes, at least a portion of each of the modulator electrodes disposed in the first plane; and
an optical material disposed in a second plane adjacent the first plane.

2. The photonics device of claim 1, wherein the optical material comprises a non-linear optical material.

3. The photonics device of claim 2, wherein the non-linear optical material comprises lithium niobate.

4. The photonics device of claim 1, further comprising:
one or more active devices.

5. The photonics device of claim 4, wherein the one or more active devices comprise one or more germanium-based diodes.

6. The photonics device of claim 4, wherein the one or more active devices comprise at least one highly doped n-region and at least one highly doped p-region.

7. The photonics device of claim 1, wherein the optical material forms at least part of an indium phosphide device.

8. The photonics device of claim 7, further comprising:
one or more active devices.

9. The photonics device of claim 8, wherein the one or more active devices comprise one or more germanium-based diodes.

10. The photonics device of claim 8, wherein the one or more active devices comprise at least one highly doped n-region and at least one highly doped p-region.

11. A photonics stack comprising:
a silicon layer comprising an active device and positioned in a first plane, wherein the active device is disposed at a lateral position of the silicon layer; and
a lithium niobate structure positioned in a second plane adjacent the first plane, wherein the lithium niobate structure is disposed at the lateral position.

12. The photonics stack of claim 11, wherein the active device comprises a germanium-based diode.

13. The photonics stack of claim 11, wherein the active device comprises at least one highly doped n-region and at least one highly doped p-region.

14. The photonics stack of claim 11, wherein the silicon layer further comprises one or more waveguides.

15. The photonics stack of claim 11, wherein the silicon layer further comprises one or more silicon nitride regions.

16. A method of fabricating a photonics stack, the method comprising:
providing a silicon photonics structure that comprises a silicon substrate, an oxide layer, and an epitaxial silicon layer with one or more active devices;
providing an interposer structure;
attaching the silicon photonics structure and the interposer structure;
removing the silicon substrate from the silicon photonics structure;
removing at least a portion of the oxide layer from the silicon photonics structure;
disposing a thin film lithium niobate coupon on or within the silicon photonics structure; and
encapsulating the thin film lithium niobate coupon with an optical material.

17. The method of claim 16, wherein the optical material has a refractive index substantially matching a refractive index of the oxide layer.

18. The method of claim 16, wherein at least one of:
removing the silicon substrate is performed using a chemical mechanical polishing; and
removing the oxide layer is performed using a reactive ion etch followed by a buffered oxide etch.

19. The method of claim 16, wherein the one or more active devices comprise at least one of:
one or more germanium-based photodiodes; and
at least one highly doped n-region and at least one highly doped p-region.

20. The method of claim 16, wherein the epitaxial silicon layer comprises at least one of:
at least one waveguide;
at least one silicon nitride region; and
one or more metal interconnect layers.

21. The method of claim 16, wherein the thin film lithium niobate coupon comprises at least one of:
an insulator layer;
a handle substrate; and
a polymer dielectric.
